(19) United States
(12) Patent Application Publication
(10) Pub. No.: US 2005/0225079 A1
(43) Pub. Date: Oct. 13, 2005

(54) Optically variable tamper evident device

(76) Inventor: Marc O. Woontner, Oceanport, NJ (US)

Correspondence Address: TAYLOR & AUST, P.C.;ILLINOIS TOOL WORKS INC., 142 S. MAIN ST, PO BOX 560, AVILLA, IN, 46710, US

(21) Appl. No.: 11/047,409

(22) Filed: Jan. 31, 2005

Related U.S. Application Data
(60) Provisional application No. 60/561,752, filed on Apr. 13, 2004.

(51) Int. Cl. B42D 15/00

(52) U.S. Cl. 283/110; 283/81

(57) ABSTRACT

A tamper evident system and method provides a clear cover for information on an object to be retained as secure. The cover has an optically variable image therein within at least two regions on opposite sides of a line along which the cover is separated or separable upon lifting the cover or a part thereof from the object. If one or both regions are lifted, characteristics of the image are altered to allow detection of tampering.

### CROSS-REFERENCE TO RELATED APPLICATIONS

The present regular United States Patent Application claims the benefits of U.S. Provisional Application Ser. No. 60/561,752 filed Apr. 13, 2004.

### FIELD OF THE INVENTION

The present invention pertains generally to tamper evident surface protection systems for plastic and paper cards as well as other identification documents wherein surface protection is required to secure and protect data on the documents from surface wear, counterfeiting and/or alternation, and, more particularly to such tamper evident systems employing holographic or optically variable images and/or patterns.

### BACKGROUND OF THE INVENTION

It is known to apply clear plastic pouches, patches, laminates or coverings to protect printed data, photos and other data on the surface of plastic or paper cards, passports and other types of security or identifying documents from the normal wear and tear commonly caused by handling and use. A polyester or other plastic film cover on the surface of the document discourages alteration of the information contained on the document, thereby providing a limited degree of security for the information. Clear polyester or other plastic film patches or laminates of this type are known to be applied by heat and pressure to the surface of the card or document. However, such covers can also be removed by heating the patch and lifting it from the surface of the document. Once the polyester or other plastic film is removed, the information contained on the document can easily be altered or counterfeited. After the information on the document has been changed, a new, plain, clear polyester cover could be applied, making the altered document appear original.

To apply a degree of security to such documents having polyester or other plastic film patches, it is known to use holograms or optically variable images or patterns as part of the polyester patch or surface cover. Such security patches include optically variable, holographic or diffractive mechanical images and/or patterns that are permanently embossed into the thermoplastic itself or into coatings applied to the underside of each patch during the manufacturing process. After the image or pattern is embossed, cast or otherwise created on the patch, a heat activated adhesive is applied to the patch during the manufacturing process. While a patch of this type can be removed, if replaced with a clear patch it becomes evident that the document has been altered since the optically variable image is no longer present on the covering for the document. Due to the complexity and cost of the machinery and processes required for creating the optically variable images and the difficulty associated with replicating an optically variable image such as a hologram or the like, counterfeiting and/or alteration have been reduced as compared to the counterfeiting or alteration of documents having simply clear polyester patches. However, as new technology has evolved, and as the inherent value of the documents and the information contained thereon has increased, there is a continued need and desire to provide more effective and improved tamper evident systems to stay one evolutionary step ahead of those who would attempt to counterfeit or tamper with such documents.

Other tamper evident systems are also known such as, for example, “breakaway” coatings, invisibly printed patterns or voids or visible security printing using relatively expensive UV, IR or other covert ink techniques. Such known systems have other problems pertaining to the coating materials. Differential coatings are inconsistent and difficult to control during manufacture. Breakaway chemistry that interrupts the adhesion of the patch to the card or document or printed or silk screened tamper evident features that are easy to replicate using common inks, coatings or even other counter chemistry. Thus, there is a continuing need to develop new, cost effective and highly secure, physically stable tamper evident systems.

### SUMMARY OF THE INVENTION

The present invention provides a tamper evident system for an object having secure data printed or applied thereon by other transferable means, which system includes a film having an optically variable image or hologram which, if tampered with, alters the image in such a way as to be detectable upon scrutiny.

In one aspect thereof, the present invention provides a tamper evident patch for protecting information on a substrate, such as plastic or paper, with a film attachable to a surface of the substrate. The film patch or lamination has predetermined regions adjacent to each other but separated by a die-cut, perforation, slit, or other demarcation line between the regions. The regions are separated from or separable from each other along the demarcation line. An optically variable image or hologram is embossed, cast or otherwise placed in specific locations on the film and overlap the demarcation line or lines. The image or pattern has sufficiently fine optically variable or holographic detail components thereof to exhibit alterations upon separation of at least one of the specified regions from the substrate.

In another aspect thereof, the present invention provides a tamper evident object with a substrate having a surface to be protected and a film on the surface of the substrate. An optically variable image or pattern incorporated on the film has designated areas in specific regions of the film. A demarcation line between the regions causes the regions to be separable from each other along the demarcation line if removal of the film is attempted. The image has sufficiently fine detail therein to exhibit variations or misalignment between the regions upon separation of at least one of the regions from the substrate.

In a further aspect thereof, the present invention provides a method for manufacturing a tamper evident object having a substrate, such as an identification card or passport, with information placed, transferred or printed thereon. The method has steps of providing a film through which the information on the substrate can be easily read or detected; creating an optically variable image, such as a hologram, on the film; attaching the film to the surface; and at least one of weakening and cutting the substrate along a demarcation line through the image to define regions in the film on opposite sides of the demarcation line.

In a still further aspect thereof, the present invention provides a method for detecting the potential tampering of a document. The document has a film thereon, and the film has an optically variable image therein. The method includes locating different areas of the optically variable image and at least one demarcation line through the image separating the areas from each other; evaluating characteristics of the image on opposite sides of the demarcation line; and determining variations in the image, such as alignment, on opposite sides of the demarcation line to determine if alteration or removal has been attempted.

An advantage of the present invention is providing a tamper evident system that improves the security over known systems at minimal increased cost.

Another advantage of the present invention is providing an improved tamper evident system that can be incorporated with existing processes.

Still another advantage of the present invention is providing a tamper evident system that is inexpensive, efficient and reliable.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of a supply roll of tamper evident patches in accordance with the present invention;

FIG. 2 is a schematic representation of a process for applying the tamper evident patches to documents or objects, paper or plastic using heat and/or pressure;

FIG. 3 is a perspective view of a document or object having a tamper evident patch in accordance with the present invention thereon;

FIG. 4 is a perspective view of a tamper evident document or object showing portions of the patch being removed;

FIG. 5 is a perspective view similar to that of FIG. 4 but illustrating a different portion of the patch being removed; and

FIG. 6 is a plan view illustrating a magnified portion of the patch and demonstrating the manner in which tampering can be evident.

Before the embodiments of the invention are explained in detail, it is to be understood that the invention is not limited in its application to the details of construction and the arrangements of the components set forth in the following description or illustrated in the drawings. The invention is capable of other embodiments, such as, but not limited to, transparent pressure sensitive labels or laminating films, and of being practiced or being carried out in various ways. Also, it is understood that the phraseology and terminology used herein are for the purpose of description and should not be regarded as limiting. The use herein of “including”, “comprising” and variations thereof is meant to encompass the items listed thereafter and equivalents thereof, as well as additional items and equivalents thereof.

### DETAILED DESCRIPTION OF THE PREFERRED EMBODIMENT

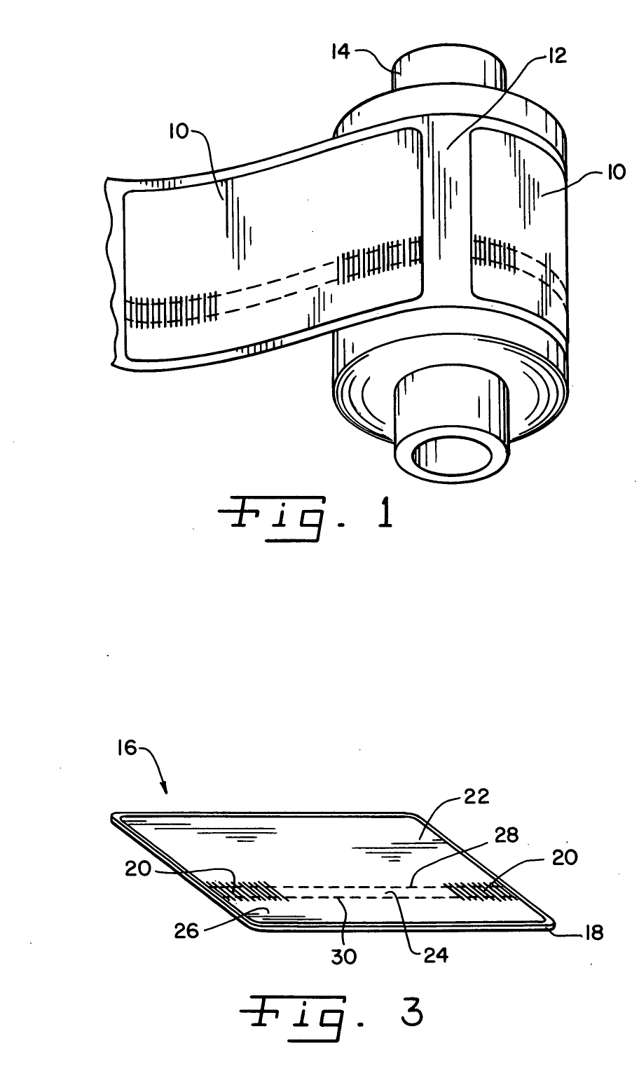

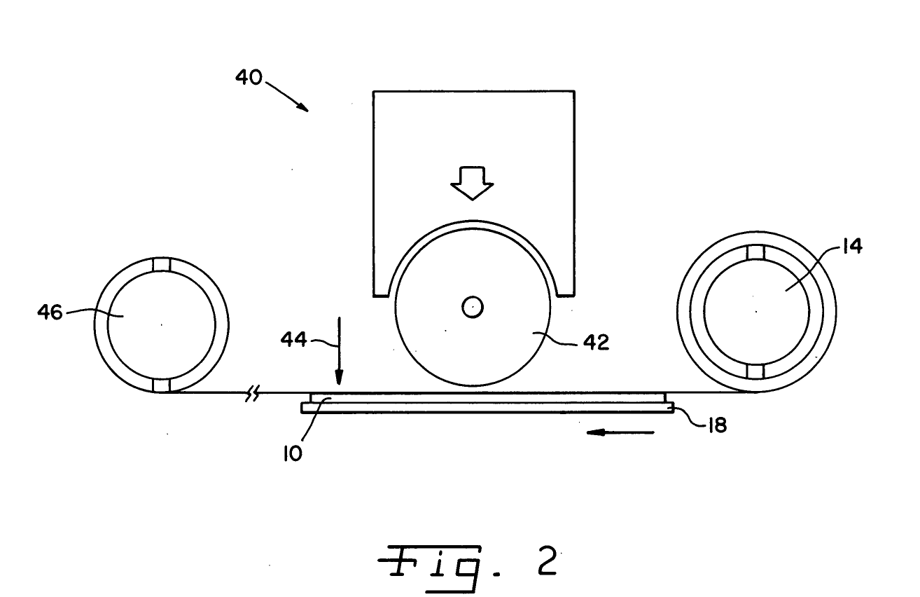

Referring now more specifically to the drawings and to FIG. 1 in particular, numeral 10 designates a tamper evident patch in accordance with the present invention. FIG. 1 shows a plurality of individual patches 10 provided as part of a web 12 on a spool 14 suitable for application, as will be described in more detail hereinafter. A document or object 16 (FIG. 3) includes tamper evident patch 10 applied to a surface of a substrate 18 having information thereon to be protected.

Object 16, as shown in FIG. 3, is a credit card, identification card, license, passport or other similar device having confidential or at least significant information or data thereon, the security and integrity of which is important. While illustrated as a card, it should be understood that object 16 can be another type of document, and that tamper evident patch 10 of the present invention can be used to protect and secure the information on such documents. Tamper evident patch 10 is applied over the confidential or other secure information on substrate 18, so that tampering or altering of the information requires removal of all or a part of patch 10. According to the present invention, the removal of patch 10, or a portion thereof, is detectable as evidence of potential tampering with the information on object 16.

Patch 10 is a film of polyester or other transparent material through which the information on substrate 18 can be viewed or perceived. An image 20 in the nature of an optically variable, holographic or diffractive mechanical image is permanently embossed, cast or otherwise affixed into or onto patch 10. As those skilled in the art will understand, image 20 can be formed by embossing or casting on or into the film or any of the layers of thermoplastic coatings provided on patch 10. Such coatings may include, for example, an adhesion promoter, a color or tint coating, an embossing coat with a coating having a high index of refraction. Final coatings are preferably applied after image 20 is created, and may include, for example, a primer or tie coating and a layer of heat or pressure sensitive adhesive for bonding patch 10 to substrate 18. The manner in which such images are created on patch 10 is known to those skilled in the art and will not be described in further detail herein.

Image 20 is illustrated in the drawings as a plurality of lines, but may take the form of color shifting or diffractive patterns or images in the form of pictures or other suitable indicia, such as official seals and emblems, grids or any graphic design produced holographically or by optically variable techniques. For example, official government documents such as drivers' licenses and the like are known to be provided with holograms of the official state seal, a state map, or other readily recognizable emblem of authenticity. Identification cards, credit cards and the like are known to include holographic or optically variable images of recognizable logos and the like. While shown only on parts of patch 10, image 20 can be provided on all of patch 10 or in one or more discrete areas of patch 10.

Patch 10, as illustrated, is provided with two or more defined regions 22, 24, 26, three said regions 22, 24, 26 being shown in the drawings. It should be understood that patch 10 of the present invention can be provided with two regions, three regions or with more than the three regions, as suitable for the particular application and use of the present invention. Regions 22, 24 and 26 are defined one from another by demarcation lines 28 and 30. Demarcation lines 28 and 30 are shown in the exemplary embodiment of the drawings to be substantially straight lines extending from one side of patch 10 to an opposite side of patch 10, to define substantially rectangular regions 22, 24, 26 of similar lengths but of different widths. In another embodiment only two regions are provided in patch 10, and only a single demarcation line is required. In embodiments with more than three regions, more than two demarcation lines may be necessary. It should be further understood that demarcation lines 28, 30 need not be straight but can be curved, wavy, zigzag or otherwise shaped. Further, each region need not necessarily extend completely across patch 10. For example, one region can be separated from another region as being a circle in the middle of the other region, or as a square or other shape within the field of the other region.

Demarcation lines 28, 30 are configurations within patch 10 whereby individual regions 22, 24, 26 are separated or readily separable from one another. Thus, demarcation lines 28, 30 can be in the form of lines of perforations that are completely torn if an attempt is made to lift patch 10 from substrate 18. In other embodiments, demarcation lines 28, 30 are physical cuts through patch 10 or scored lines in the thickness of patch 10 to define weakened areas of patch 10 which also are torn or separated if an attempt is made to lift patch 10 from substrate 18. Other configurations for demarcation lines 28, 30 are also contemplated, and all such embodiments for demarcation lines 28 and 30 are represented by dashed lines in the drawings. Demarcation lines 28, 30 are such that if all or part of patch 10 is lifted from substrate 18, physical separation occurs between adjacent regions 22, 24, 26.

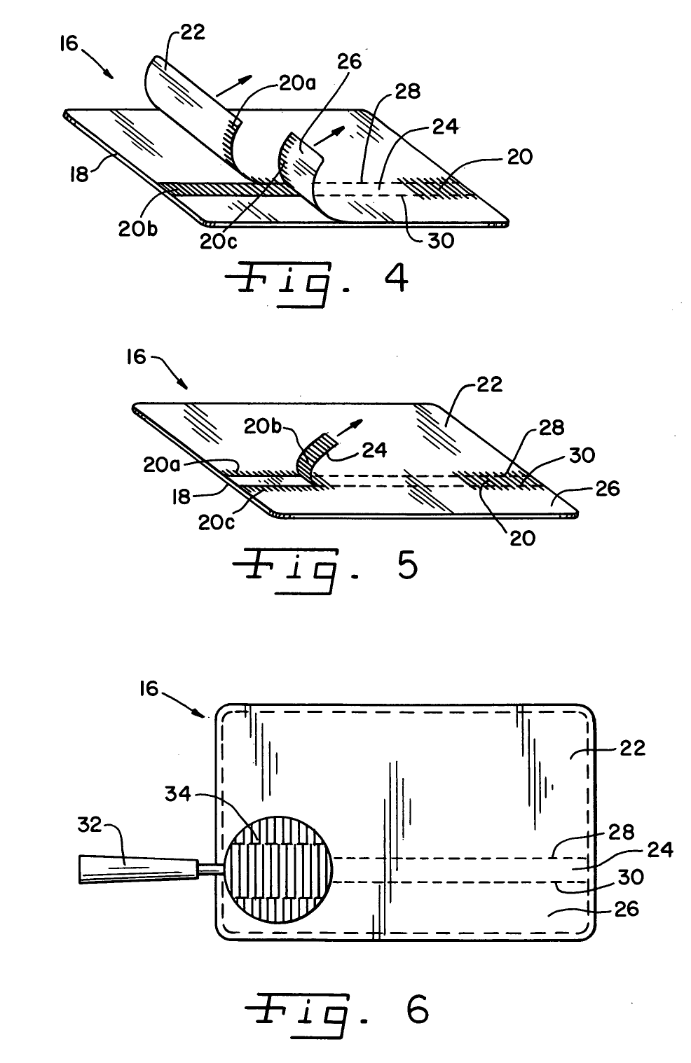

With substantially parallel adjacent regions 22, 24, 26, as illustrated in FIG. 4, if one or both of regions 22 or 26 on opposite sides of region 24 are lifted from substrate 18, physical separation, deformation or tearing occurs between adjacent regions 22, 24, 26. Thus, if region 22 is lifted away from substrate 18, physical separation occurs between regions 22 and 24, along demarcation line 28. Similarly, if region 26 is lifted away from substrate 18, physical separation occurs between regions 26 and 24, along demarcation line 30. As illustrated in FIG. 5, similar separation occurs if only the middle region 24 is lifted from substrate 18. Physical separation occurs between regions 22 and 24, and between regions 24 and 26, along both demarcation lines 28 and 30.

Image 20 extends over one or both demarcation lines 28, 30, and in the embodiment shown has area 20a, 20b and 20c thereof in regions 22, 24 and 26, respectively. Image 20 includes sufficiently fine detail graphics that exhibit optically variable or holographic characteristics that, if patch 10 is tampered with in an attempt to separate it from substrate 18, the physical separation along one or more of demarcation lines 28 and 30 will lead to distortion or misalignment in the image on opposite sides of demarcation lines 28 and 30.

The material of patch 10 generally expands when heated and contracts when cooled. Thus, if heat is applied to soften adhesive to remove a portion or all of patch 10, expansion occurs during heating and contraction occurs when the patch again cools. However, the amount of expansion and contraction is dependent on the size of the associated piece being expanded or contracted. With regions 22, 24, 26 being of different sizes and/or shapes, the amount of expansion and contraction differs from one region to another region. Further, manipulation and handling of regions 22, 24, 26 can cause the material to stretch in different ways, depending on the sizes and shapes of regions 22, 24 and 26.

Image 20 is configured and placed in such a way that a portion of the image remains with one region 22, 24, 26 of the patch when separation occurs along demarcation lines 28 or 30 and another portion of image 20 remains with the adjacent region 22, 24 or 26. When an attempt is made to put regions 22, 24 and 26 back together, portions of the image or pattern can not be aligned on account of the varying stretch and shrinkage rates for the different regions. As a result, an inspector or investigator, perhaps with the aid of a visual enhancing device, such as, for example, a magnifying glass 32 (FIG. 6) can locate areas 20a, 20b and 20c of image 20 and demarcation lines 28 and 30 between the areas of the image. The inspector evaluates and compares features on opposites sides of demarcation lines 28, 30 to detect that alternation and/or counterfeiting has been attempted due to the misalignment or other distortion of lines and patterns in image 20. A distorted image 34 is shown in FIG. 6, represented by a series of discontinuous lines. If something within the image is perceived to be amiss, the card or document can be marked as void, suspect or otherwise removed or rejected from legitimate use.

In one method of applying patch 10 the film of material is provided and an image 20 is created thereon. Film 10 is applied to substrate 18 in a laminating or pressure activated process 40, as shown in FIG. 2, wherein patches 10 are provided from spool 14 having web 12 thereon. Prior to applying film 10 to substrate 18, information or data is preferably printed or otherwise put on the substrate 18. Web 12 can be a continuous length of the film from which multiple patches 10 are made, or web 12 can be a carrier web holding a plurality of individual patches 10 appropriately spaced and carried for bonding to individual pieces of substrate 18. Patch 10 is applied to substrate 18 using heat and pressure from a laminating roll 42, or pressure alone if a pressure sensitive adhesive is used. Demarcation lines 28, 30 are created in patch 10 preferably before patch 10 is applied to substrate 18, but after the hologram or optically variable image is embossed, cast or otherwise affixed into the patch 10 and the final adhesive is applied to the patch 10. Demarcation lines 28, 30 can be made by die cutting, cutting with a rotary wheel or the like preferably during the patch production process, or, alternatively, after lamination, as indicated by the arrow designated with numeral 44 in FIG. 2. In yet another alternative arrangement, creation of demarcation lines 28, 30 may occur some distance downstream from laminating roll 42, after object 16 has cooled if it was heated during the lamination process. Image 20 remains undistorted, since all of patch 10 is heated and cooled together, as a single body during the lamination process, or, in an alternative arrangement, prior to formation of demarcation lines 28, 30. In one arrangement, if a pressure sensitive adhesive is used to bond patch 10 to substrate 18, and heat is not required, creating demarcation lines 28, 30 as at line 44 can be more closely positioned to laminating roll 42. Web 12, or remnant portions thereof are collected at windup 46.

According to one aspect of the invention, if demarcation lines 28, 30 are formed with patch 10 in place on substrate 18; a complete separation in the way of a through-cut can be made between adjacent regions 22, 24, and 26. Alternatively, patch 10 can be sufficiently weakened along demarcation lines 28, 30 such as by perforations or scoring so that any slight movement of one region 22, 24, 26 relative to another region 22, 24, 26 adjacent thereto causes immediate physical separation between adjacent regions 22, 24, 26.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A tamper evident patch for protecting information on a substrate, said patch comprising:
a film attachable to the substrate, said film having first and second regions adjacent each other on opposite sides of a demarcation line between said regions, said regions being at least one of separated from each other and separable from each other along said demarcation line; and
an optically variable image on said film, said image being partly in each said first region and said second region, said image having sufficiently fine detail components thereof to exhibit alterations upon separation of at least one of said first and second regions from the substrate.

2. The tamper evident patch of claim 1, said demarcation line being perforations separating said first and second regions form each other.

3. The tamper evident patch of claim 1, said demarcation line being a through cut in said film.

4. The tamper evident patch of claim 1, said demarcation line being a weakened area between said regions.

5. The tamper evident patch of claim 4, said demarcation line being a score in said film.

6. The tamper evident patch of claim 1, said regions being of different sizes or shapes.

7. A tamper evident object comprising:
a substrate having a surface to be protected;
a film on said surface;
an optically variable image on said film;
first and second areas of said image being in first and second regions of said film;
a demarcation line between said first and second regions, said regions being at least one of separated from each other and separable from each other along said demarcation line; and
said image having sufficiently fine detail therein to exhibit variations between said regions upon separation of at least one of said first and second regions from said substrate.

8. The tamper evident object of claim 7, said demarcation line being perforations separating said first and second regions form each other.

9. The tamper evident object of claim 7, said demarcation line being a through cut in said film.

10. The tamper evident object of claim 7, said demarcation line being a weakened area between said regions.

11. The tamper evident object of claim 10, said demarcation line being a score in said film.

12. The tamper evident patch of claim 7, said regions being of different sizes or shapes.

13. The tamper evident patch of claim 7, said film having a third region and a second said demarcation line, and said image.

14. The tamper evident patch of claim 7, said demarcation line being straight.

15. A method for manufacturing a tamper evident object having a substrate with information thereon, said method comprising steps of:
providing a film through which the information on the substrate can be detected;
creating an optically variable image on the film;
attaching the film to the surface; and
at least one of weakening and cutting the substrate along a demarcation line through the image to define first and second regions in the film on opposite sides of the demarcation line.

16. The method of claim 15, including perforating the substrate along the demarcation line through the image.

17. The method of claim 15, including cutting the substrate along the demarcation line through the image.

18. The method of claim 15, including scoring the substrate to weaken the substrate along the demarcation line through the image.

19. The method of claim 15, including weakening the substrate along the demarcation line through the image.

20. A method for detecting the potential tampering of a document, the document having a film thereon and the film having an optically variable image therein, the method comprising:
locating first and second areas of the optically variable image and a demarcation line through the image separating the first and second areas from each other;
evaluating characteristics of the image on opposite sides of the demarcation line; and
determining variations in the image on opposite sides of the demarcation line.
